(19) United States
(12) Patent Application Publication
(10) Pub. No.: US 2013/0181465 A1
(43) Pub. Date: Jul. 18, 2013

(54) OPTICAL DISC RESTORATION METHOD AND SYSTEM

(71) Applicants: Takakazu MIYAHARA, Minamisatsuma-shi (JP); Terumasa MIYAHARA, Minamisatsuma-shi (JP); Kengo WADA, Minamisatsuma-shi (JP)

(72) Inventors: Takakazu MIYAHARA, Minamisatsuma-shi (JP); Terumasa MIYAHARA, Minamisatsuma-shi (JP); Kengo WADA, Minamisatsuma-shi (JP)

(73) Assignee: ELM INC., Minamisatsuma-shi (JP)

(21) Appl. No.: 13/351,949

(22) Filed: Jan. 17, 2012

(51) Int. Cl. B66C 1/10; B66C 1/54; B23P 6/00

(52) U.S. Cl. 294/90; 29/402.18; 29/650; 294/93

(57) ABSTRACT

After a scratch 160 or similar defect formed on the readout surface of an optical disc is nearly completely removed by grinding and polishing the readout surface with surface with a grinding/polishing agent or similar compound, the readout surface is coated with a coating agent 170 made of a transparent resin or similar material. In this process, a significant change in the thickness of the optical disc before and after the restoration can be prevented by controlling the grind/polishing and coating processes so that the decrease in the thickness due to the grinding/polishing is nearly equal to the increase in the thickness due to the application of the coating agent 170. Therefore, even a Blu-ray Disc or similar optical disc having only a small distance from the surface to the information record layer can be restored many times.

### TECHNICAL FIELD

The present invention relates to a method and system for restoring an optical disc, such as a compact disc (CD), digital versatile disc (DVD) or Blu-ray Disc™ (BD), by removing scratches and other defects from its readout surface.

### BACKGROUND ART

Optical disks, such as CDs, DVDs and BDs, are made of a transparent resin (although some products are colored within the visible light region) and normally have a thickness of approximately 1.2 mm and a diameter of 120 mm, with a central hole of 15 mm in diameter.

FIGS. 17A and 17B are diagrams each showing the structure of a commonly used optical disc 100. Specifically, FIG. 17A is a plan view and FIG. 17B is a sectional view at the arrowed line X-X in FIG. 17A, each view showing a CD or DVD on the right half and a BD on the left. FIG. 18 is an enlarged sectional view of a single-layer BD with the readout surface directed upwards. This disc has a substrate 120 made of a polycarbonate resin or similar material having a thickness of approximately 1.1 mm, with an information record layer 130 formed thereon. A cover layer 140 of approximately 0.1 mm in thickness and a hard-coating layer 150 of approximately 3-5 μm in thickness are formed on the information record layer 130.

An optical disc holds information in its specific layer; in CDs, this layer is located on the side opposite to the readout surface, while DVDs have this layer at a depth of approximately 0.6 mm from the readout surface. In BDs, the information is recorded in a layer 0.1 min below the readout surface. The information held in the information record layer can be read by casting a laser beam onto this layer through the readout surface and detecting a reflected light coming from the same layer.

Therefore, in principle, if the readout surface of the optical disc is scratched, the information cannot be correctly read because the laser beam for reading the information and the reflected light coming from the information record layer are reflected or scattered at the scratched portion.

As already explained, the information held in the optical disc is not recorded on the readout surface but in the information record layer beneath the surface. Therefore, a scratch on the readout surface does not directly damage the information. Accordingly, if the information record layer is safe, it is possible to read the information once more by removing the scratch from the readout surface.

Optical disc restoration systems for grinding and polishing an optical disc to remove a scratch from its readout surface have been conventionally known (for example, refer to Patent Document 1). One example of the conventional optical disc restoration systems includes a rotary table on which an optical disc to be restored can be set, a disc-shaped grind/polisher, and other components. This system grinds and polishes the readout surface of an optical disc by rotating both the grind/polisher and the rotary table while maintaining the grind/polisher in contact with the readout surface.

### BACKGROUND ART DOCUMENT

### Patent Document

Patent Document 1: JP-A 2005-310211

### DISCLOSURE OF THE INVENTION

### Problem to be Solved by the Invention

The aforementioned conventional system restores an optical disc by grinding away its readout surface by a thickness approximately equal to the depth of the scratch and mirror-polishing the same surface. Accordingly, the optical disc becomes thinner for every restoration, so that the disc can be restored only a limited number of times.

The largest thickness that can be ground away is approximately 0.4 mm for CDs (in which the distance from the readout surface to the information record layer is 1.2 mm) and approximately 0.2 mm for DVDs (in which the distance from the readout surface to the information record layer is 0.6 mm). The largest possible number of restorations for deep scratches is approximately 40 times for CDs and 20 times for DVDs. By contrast, for BDs, in which the distance from the readout surface to the information record layer is 0.1 mm, the largest thickness that can be ground away is no greater than approximately 0.02 mm. Another problem results from the presence of the hard coating layer having a thickness of only a few μm. This layer is intended to impede the formation of scratches on the readout surface, and the disc will be more easily scratched without this layer. Accordingly, the restoration process is limited to only shallow scratches formed in the hard coating layer.

The present invention has been developed in view of the previously described problems. Its objective is to provide an optical disc restoration method and system which have no limitation on the number of restorations and by which BDs or similar disks having a small distance from the readout surface to the information record layer can be restored many times.

### Means for Solving the Problems

An optical disc restoration method according to the first aspect of the present invention aimed at solving the previously described problems includes the steps of:

a) grinding and polishing the readout surface of an optical disc;

b) cleaning the optical disc while the optical disc is being ground or polished and/or after the optical disc is polished; and

c) coating the readout surface of the cleaned optical disc with a coating agent.

In the optical disc restoration method according to the first aspect of the present invention, a scratch or similar defect formed on the readout surface of an optical disc is almost completely removed by grinding and polishing the readout surface with a grinding/polishing agent or similar compound, after which the readout surface is coated with a coating agent made of a transparent resin or similar material. In this restoration process, a significant change in the thickness of the optical disc before and after the restoration can be prevented by controlling the grind/polishing and coating processes so that the decrease in the thickness in the grind/polishing step will be nearly equal to the increase in the thickness in the coating step. When a material whose hardness is nearly equal to the hardness of the readout surface before the grind/polishing is used as the coating agent, the surface hardness after the restoration will be comparable to the level before the restoration.

FIGS. 1A-1C schematically illustrate the optical disc restoration method according to the present invention. Each of the FIGS. 1A-1C is an enlarged view of an optical disc with the readout surface directed upwards and corresponds to the portion surrounded by circle A in FIG. 18. Specifically, FIG. 1A shows the readout surface with scratches 160, FIG. 1B shows the readout surface from which a surface layer with scratches 160 has been ground away, and FIG. 1C shows the readout surface with a coating agent 170 applied thereto by a thickness corresponding to the thickness that has been ground away.

One preferable example of the coating agent is a type of resin that is transparent to the wavelength of a laser beam used for reading information. In particular, for the restoration of BDs, a transparent resin whose hardness in the cured state is comparable to that of the aforementioned hard coating layer (e.g. 2H or higher in terms of pencil hardness) is desirable as the coating agent. The method for grind/polishing an optical disc in the grind/polishing step is not limited to any specific method. Possible examples include a method using a coarse grind/polisher (such as sandpaper), a method using a grinding/polishing agent (compound) in the form of a liquid held in a “buff”, which is a holding body made of cloth or sponge, as well as the combination of these two methods. The aforementioned coating agent may be colored with a dye. This makes it easy to visually distinguish between disks which have undergone the coating process from other disks (i.e. disks which have not been polished yet or which have undergone the grind/polishing process but not yet the coating process) after the grind/polishing.

An optical disc restoration system according to the second aspect of the present invention aimed at solving the previously described problems includes:

a) a grind/polisher for grinding and polishing the readout surface of an optical disc;

b) a cleaner for supplying a cleaning liquid to the readout surface of the optical disc while the optical disc is being ground or polished and/or after the optical disc is polished; and

c) a coating-agent supplier for applying a coating agent to the readout surface of the cleaned optical disc.

The optical disc restoration system according to the present invention is a system for realizing the previously described optical disc restoration method according to the present invention. The grind/polisher is not limited to any specific type. For example, it may include a grind/polisher holder for holding a grind/polisher (such as sandpaper), a disc holder for holding an optical disc, and a mechanism for rotating the grind/polisher holder and/or the disc holder while pressing the grind/polisher onto the optical disc so as to grind and polish the readout surface of the optical disc. In addition to or in place of a coarse grind/polisher (such as sandpaper), a grind/polisher made of a holder of cloth or sponge (i.e. a “buff”) and a grinding/polishing agent in the form of a liquid may be used for the grinding/polishing. As already explained, one preferable example of the coating agent applied by the coating-agent supplier is a type of resin that is transparent to the wavelength of a laser beam used for reading information. The coating agent may be colored with a dye.

The optical disc restoration system may be configured so that the optical disc is placed at the same position throughout the processes performed by the aforementioned devices (i.e. the grind/polisher, the cleaner and the coating agent supplier). However, to improve the processing efficiency, it is preferable to perform the processes by the aforementioned devices at different positions in the system, while moving the optical disc from one position to another by a transfer mechanism to sequentially perform a series of processes.

The aforementioned transfer mechanism requires a pick-up mechanism for picking up an optical disc placed at a predetermined position. A disc pick-up mechanism commonly used in conventional optical disc restoration systems picks up a disc by attracting its readout surface by suction through a vacuum pad. However, such a pick-up mechanism cannot be used in the optical disc restoration system according to the present invention since this system applies a coating agent to the optical disc after the polishing; the aforementioned pick-up mechanism using a vacuum pad cannot pick up the optical disc before the coating agent is cured. To address this problem, the present invention also provides a disc pick-up mechanism suitable for transferring an optical disc in the restoration system of the present invention.

The disc pick-up mechanism according to the third aspect of the present invention includes:

a) a plurality of disc-holding rods extending in the vertical direction;

b) a first driver for vertically moving the disc-holding rods; and

c) a second driver for horizontally moving each of the disc-holding rods so that the disc-holding rods move closer to or away from each other,

whereby a horizontally placed optical disc can be held in such a manner that the disc-holding rods being held closer to each other by the second driver are inserted from above into the central hole of the optical disc by the first driver, and then the disc-holding rods are moved away from each other by the second driver so that the circumferential surface of each of the disc-holding rods comes in contact with the inner wall of the central hole.

By this disc pick-up mechanism, an optical disc can be held at its central hole. Therefore, even an optical disc fresh from the application of a coating agent can be picked up without causing any damage to the coating.

In one preferable mode of the disc pick-up mechanism according to the third aspect of the present invention, each of the disc-holding rods has an inclined portion on the side that faces the inner wall of the central hole of the optical disc when the optical disc is held by the disc-holding rods, the inclined portion being inclined downwards toward the circumference of the optical disc and designed to support the optical disc from below by coming in contact with the lower end of the inner wall of the central hole of the optical disc.

The previously described disc pick-up mechanism according to the third aspect of the present invention may further include a plurality of upper-side stopping members which come in contact with the upper side of the optical disc at a portion around the central hole thereof when the optical disc is held by the disc-holding rods.

By this mechanism, the optical disc is held from both the upper and lower sides at a portion around the central hole. Therefore, the optical disc can be held in a stable manner.

As an alternative to the upper-side stopping members, a projection protruding toward the circumference of the optical disc may be provided above the inclined portion on at least a portion of the disc-holding rods so that the lower surface of the projection will come in contact with the upper side of the optical disc at a portion around the central hole thereof when the optical disc is held by the disc-holding rods.

### Effect of the Invention

As described thus far, with the optical disc restoration method and system according to the present invention, it is possible to restore an optical disc without causing a significant change in the thickness of the disc. Accordingly, there is no limitation on the number of restorations. Even a BD or similar disc having only a small distance between the readout surface and the information record layer can be restored many times. When a material whose hardness is nearly equal to the hardness of the readout surface of the optical disc before the restoration is used as the coating agent, the surface hardness after the restoration will be comparable to the level before the restoration.

### BRIEF DESCRIPTION OF THE DRAWINGS

FIGS. 1A-1C are model diagrams schematically illustrating an optical disc restoration method according to the present invention, where FIG. 1A shows a readout surface with scratches, FIG. 1B shows the readout surface from which a surface layer with scratches has been ground away, and FIG. 1C shows the readout surface with a coating agent applied thereto.

FIG. 2 is a perspective view of an optical disc restoration system according to one embodiment of the present invention.

FIG. 3 is a plan view of the optical disc restoration system according to the same embodiment.

FIG. 4 is a side view of the disc-holding mechanism in the optical disc restoration system according to the same embodiment.

FIG. 5 is a bottom view of the same disc-holding mechanism in a released state.

FIG. 6 is a bottom view of the same disc-holding mechanism in a holding state.

FIGS. 7A and 7B show the tip portion of the same disc-holding mechanism in the released state (FIG. 7A) and the holding state (FIG. 7B), where, in each figure, the upper part is a plan view and the lower part is a sectional view at the arrowed line X-X in the upper part.

FIG. 8 is a flowchart showing the steps of a restoration process by the optical disc restoration system according to the same embodiment.

FIGS. 9A and 9B show the tip portion of a central shaft, where FIG. 9A is a plan view and FIG. 9B is a sectional view at the arrowed line X-X in FIG. 9A.

FIGS. 10A and 10B are vertical sectional views showing the central shaft and the disc-holding mechanism in a disc pick-up operation, where FIG. 10A shows the released state and FIG. 10B shows the holding state.

FIG. 11 is an enlarged sectional view corresponding to the region surrounded by the circle B in FIG. 1C, illustrating a coating agent filling a scratch that has remained after the grinding/polishing process.

FIGS. 12A and 12B show the first variation of the disc-holding mechanism in the released state (FIG. 12A) and the holding state (FIG. 12B), where, in each figure, the upper part is a plan view and the lower part is a sectional view at the plane indicated by the arrowed line X-X in the upper part.

FIGS. 13A and 13B show the second variation of the disc-holding mechanism in the released state (FIG. 13A) and the holding state (FIG. 13B), where, in each figure, the upper part is a plan view and the lower part is a sectional view at the plane indicated by the arrowed line X-X in the upper part.

FIGS. 14A and 14B shows the third variation of the disc-holding mechanism, where FIG. 14A is a front view and FIG. 14B is a bottom view.

FIGS. 15A and 15B are model diagrams illustrating an operation of the third variation of the disc-holding mechanism, where FIG. 15A shows the holding state and FIG. 15B shows the released state.

FIGS. 16A and 16B are model diagrams illustrating the fourth variation of the disc-holding mechanism, where FIG. 16A shows the holding state and FIG. 16B shows the released state.

FIGS. 17A and 17B show the structure of commonly used optical disks, where FIG. 17A is a plan view and FIG. 17B is a sectional view at the arrowed line X-X in FIG. 17A, each view showing a CD or DVD on the right half and a BD on the left.

FIG. 18 is an enlarged sectional view of a single-layer BD.

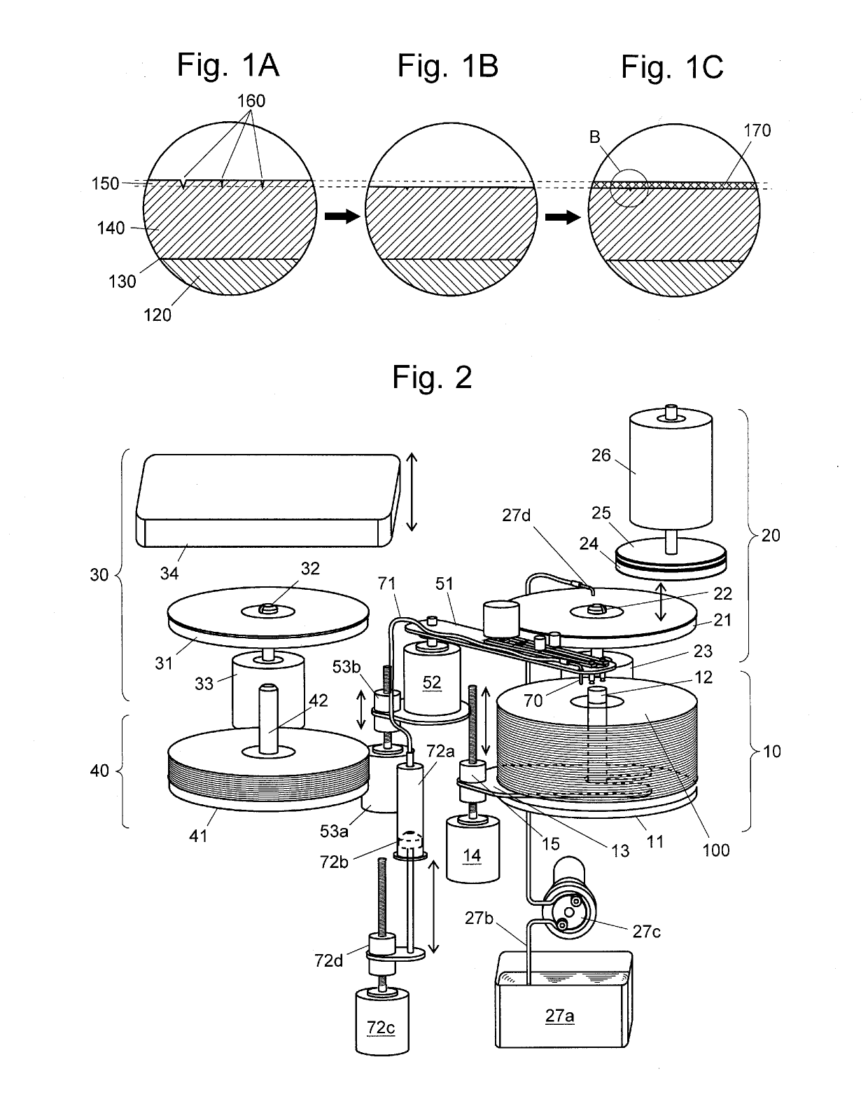

### BEST MODE FOR CARRYING OUT THE INVENTION

The optical disc restoration system according to the present invention and the method for restoring an optical disc by using the same system are hereinafter described by means of an embodiment.

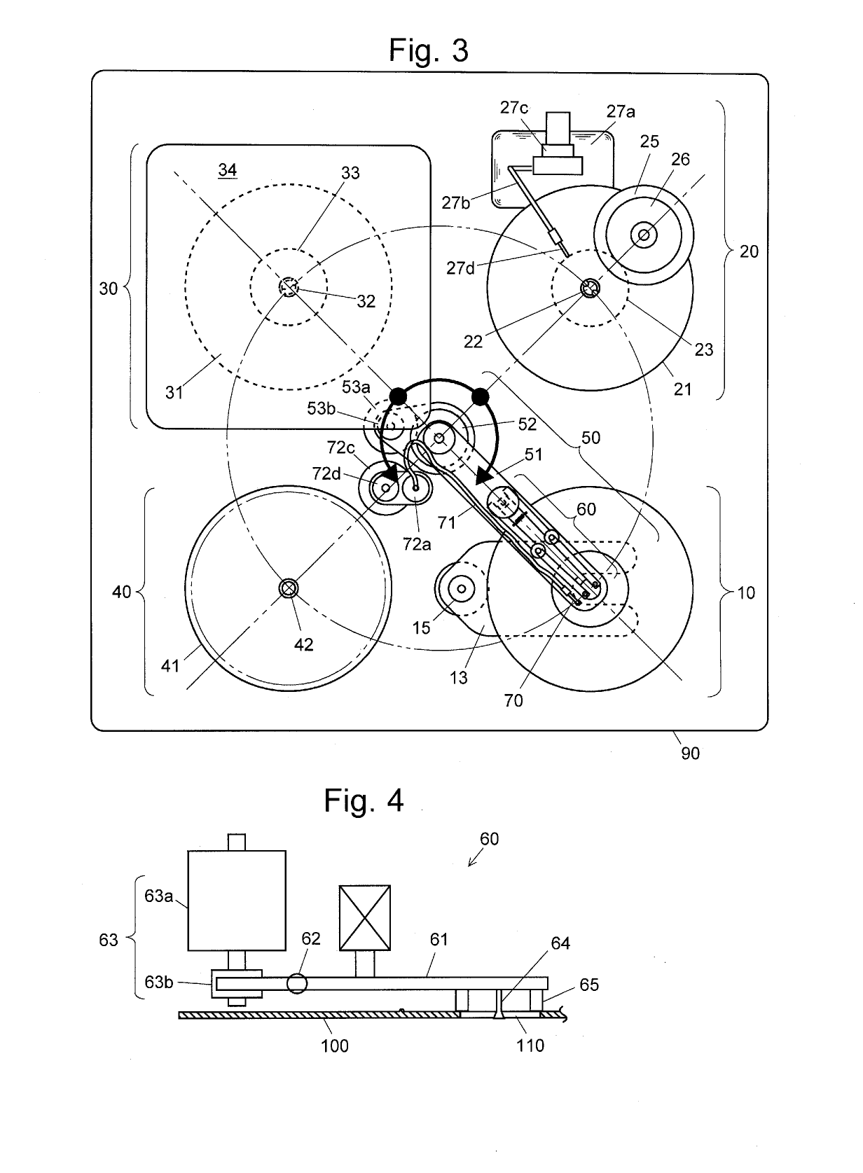

FIG. 2 is a perspective view showing the main components of the optical disc restoration system according to the present embodiment, and FIG. 3 is a plan view of the same system. It should be noted that the pedestal, the bearing and some other components are omitted for simplicity.

The restoration system according to the present embodiment is composed of five major components, i.e. a supply unit 10 for supplying an optical disc 100 to be processed, a restoration unit 20 for grinding, polishing and cleaning the optical disc 100 as well as for applying a coating agent to the same disc 100, a curing unit 30 for curing the applied coating agent, a discharging unit 40 in which the processed optical disks 100 are discharged, and a transfer mechanism 50 for transferring the optical disc 100 between the aforementioned units. These major components are contained in the same housing 90. The housing 90 should be filled with clean air produced by using a filter, such as a HEPA filter, so as to prevent dust or the like from attaching to the optical disc 100.

The supply unit 10 has a supply stage 11 with a cylindrical center pole 12 standing at its center. A lifting plate 13, which can be vertically moved by a lift drive motor 14 and a rotation-to-translation conversion mechanism 15, is provided on the supply stage 11. A plurality of optical disks 100 to be processed are stacked on the lifting plate 13 lying on the supply stage 11, with the center pole 12 passing through the central holes of the disks.

The restoration unit 20 includes a restoration table 21, on which an optical disc 100 is to be set, and a restoration table drive motor 23 for rotating the restoration table 21. Located above the restoration table 21 are a grinding/polishing pad 24 for grinding and polishing the surface of the optical disc 100, a pad holder 25 holding the grinding/polishing pad 24, and a pad drive motor 26 for rotating the pad holder 25. Though not shown in the figure, the restoration unit 20 additionally includes a pressing mechanism for vertically moving the grinding/polishing pad 24 and/or the restoration table 21 to press the grinding/polishing pad 24 onto the optical disc 100 with required pressure.

The restoration unit 20 is further provided with a liquid supply mechanism for supplying a cooling and cleaning liquid (which is hereinafter simply called the “cleaning liquid”), such as water, from a supply tank 27a, through a supply pipe 27b, supply pump 27c and supply nozzle 27d, to the surface of the optical disc 100 on the restoration table 21. By means of the liquid supply mechanism, the cleaning liquid is appropriately supplied to remove heat and shavings resulting from the process of grinding and polishing the surface of the optical disc 100 as well as to clean the surface of the optical disc 100.

The curing unit 30 includes a light source 34 for curing a light-curing resin used as a coating agent, a curing table 31 for holding an optical disc 100 with a coating agent applied thereto, and a curing table drive motor 33 for rotating the curing table 31 so as to evenly irradiate the optical disc 100 with light. Furthermore, though not shown, a lifting mechanism for vertically moving the light source 34 and/or the curing table 31 is provided so as to move the light source 34 and the optical disc 100 closer to each other during the curing process.

The discharging unit 40 has a collecting stage 41 with a center pole 42. A plurality of optical disks 100 that have undergone a series of processes are sequentially stacked on the collecting stage 41.

The transfer mechanism 50 includes a rotary arm 51 and an arm-rotating mechanism 52 for rotating this arm 51. The rotary arm 51 and the arm-rotating mechanism 52 can be vertically moved by a lifting mechanism including a motor 53a and a rotation-to-translation conversion mechanism 53b. A disc-holding mechanism 60 with a pair of open/close arms 61 (which will be described later) is provided at the tip portion of the rotary arm 51. The transfer mechanism 50, which is located at the center of the restoration system, picks up one optical disc 100 from the supply unit 10 and transfers it to the restoration unit 20, the curing unit 30, and the discharging unit 40, which are arranged in this order on the circular path of the rotary arm 51.

A coating agent ejection nozzle 70 is provided at the tip portion of the rotary arm 51 of the transfer mechanism 50. This nozzle 70 is connected to a coating agent supply mechanism via a tube 71. A syringe 72a containing a coating agent is set in the coating agent supply mechanism. A piston 72b is fitted in this syringe 72a. Pushing this piston 72b by using a motor 72c, a rotation-to-translation conversion mechanism 72d and other elements causes the coating agent to be ejected. It is not always necessary to attach the coating agent ejection nozzle 70 to the rotary arm 51. For example, it may be attached to a dedicated arm separate from the rotary arm 51 or a dedicated lifting mechanism provided in the restoration unit 20.

The disc-holding mechanism 60 provided in the transfer mechanism 50 is hereinafter described in detail.

In the case of conventional restoration systems, when an optical disc is transferred, the disc is held by attracting the readout surface by suction through a vacuum pad. However, this mechanism cannot be used in the restoration system of the present embodiment since a coating agent is applied to the optical disc after the polishing. The conventional system using the vacuum pad cannot be used for transferring an optical disc before the coating agent is cured.

To address this problem, the disc-holding mechanism 60 of the restoration system according to the present embodiment is constructed so as to hold an optical disc 100 at the central hole 110 of the disc.

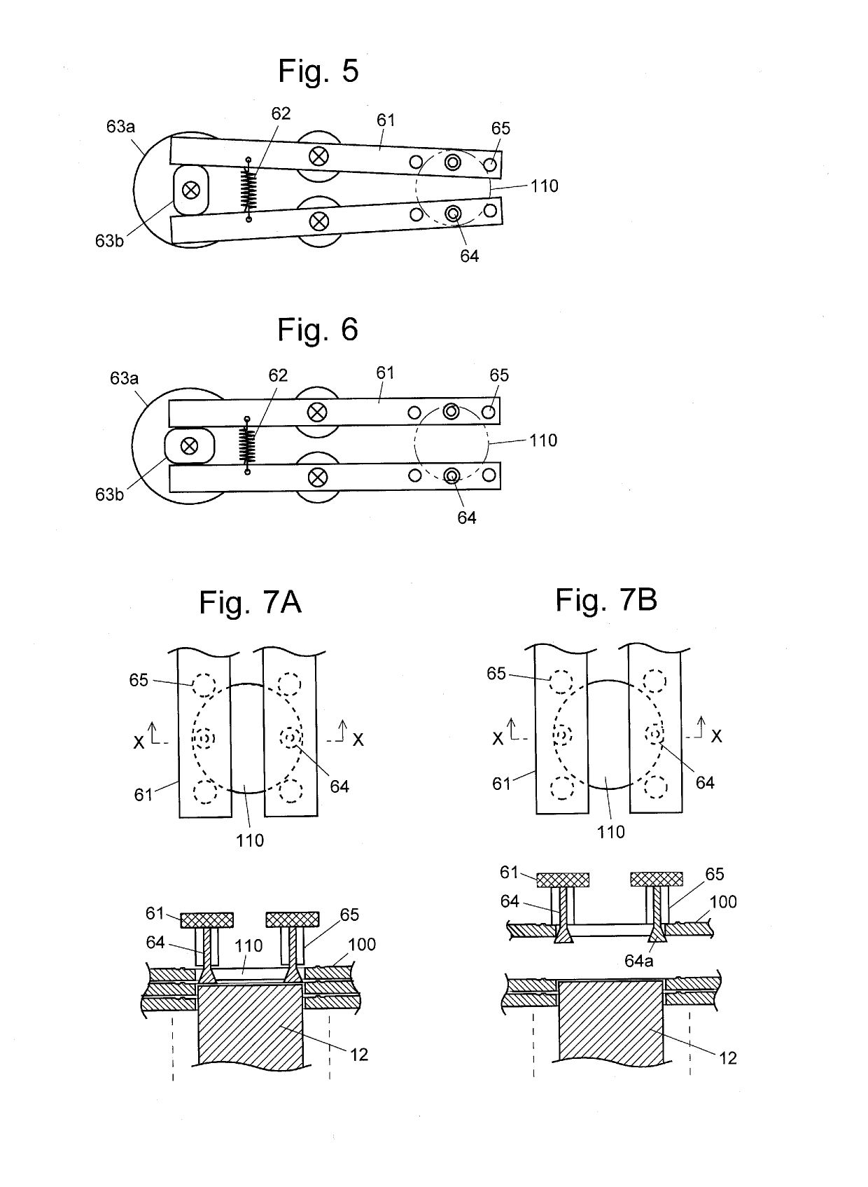

The construction of the disc-holding mechanism 60 is as shown FIGS. 4-6. The disc-holding mechanism 60 includes a pair of horizontally extending open/close arms 61, a spring 62 for opening the open/close arms 61 (i.e. for moving the tips of the two arms away from each other), as well as an arm-closing mechanism 63 including a rotary solenoid (or stepping motor) 63a, a cam 63b and other elements for closing the open/close arms 61 (i.e. for moving the tips of the two arms closer to each other).

FIGS. 7A and 7B are enlarged views showing the tip portion of the open/close arms 61. Specifically, FIG. 7A shows the state where the arms 61 hold no optical disc (this state is hereinafter called the “released state”), and FIG. 7B shows the state where the arms 61 hold an optical disc (this state is hereinafter called the “holding state”). Each of the open/close arms 61 has one disc-holding pin 64, which extends downwards from the tip portion, and a pair of upper-side stopping pins 65, which also extend downwards. Each of these pins 64 and 65 is cylindrically shaped. The disc-holding pins 64 is slightly longer than the upper-side stopping pins 65.

At the lower end of each disc-holding pin 64, a tapered portion 64a having a downward-spread conical shape is formed, whose circumferential surface is designed to come in contact with the lower end of the inner wall of the central hole 110 of the disc. Each of the upper-side stopping pins 65 is designed so that its lower surface comes in contact with a portion around the central hole 110 on the upper surface of the optical disc (i.e. on the readout surface). Thus, the disc-holding mechanism 60 according to the present embodiment can assuredly hold the optical disc 100 by supporting it at six points (four points on the upper side and two points on the lower side).

In the optical disc restoration system according to the present embodiment, the combination of the pad holder 25, the pad drive motor 26, the restoration table 21 and the restoration table drive motor 23 corresponds to the grind/polisher in the present invention. Similarly, the liquid supply mechanism corresponds to the cleaner in the present invention, and the combination of the coating agent ejection nozzle 70 and the coating agent supply mechanism corresponds to the coating agent supplier. The combination of the disc-holding mechanism 60, the motor 53a and the rotation-to-translation conversion mechanism 53b corresponds to the disc pick-up mechanism according to the present invention, where the disc-holding pins 64 correspond to the disc-holding rods in the present invention, the tapered portion 64a corresponds to the inclined portion, the upper-side stopping pin 65 corresponds to the upper-side stopping member, the combination of the motor 53a and the rotation-to-translation conversion mechanism 53b corresponds to the first driver, and the combination of the spring 62 and the arm-closing mechanism 63 corresponds to the second driver.

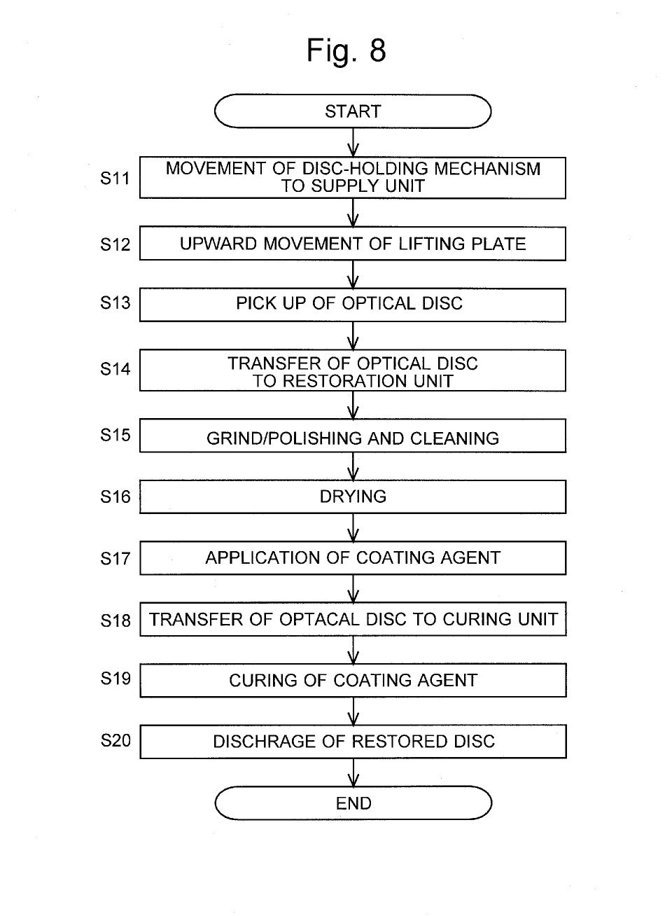

An operation procedure of the restoration system according to the present embodiment is hereinafter described with reference to the flowchart shown in FIG. 8.

(1) Movement of Disc-Holding Mechanism to Supply Unit (Step S11)

The rotary arm 51 of the transfer mechanism 50 is initially rotated until the disc-holding mechanism 60 comes to a position directly above the supply unit 10. Then, the rotary arm 51 is lowered to a level where the disc-holding pins 64 softly come in contact with the center pole 12.

(2) Upward Movement of Lifting Plate (Step S12)

Subsequently, the lift drive motor 14 is energized to move the lifting plate 13 upward until the optical disks stacked on the supply stage 11 are lifted to a level where the lower surface of the topmost disc 100 is slightly higher than the top of the center pole 12. As a result, as shown in FIG. 7A, the tips of the disc-holding pins 64 of the disc-holding mechanism 60 reach the level slightly below the lower surface of the topmost disc 100 of the stacked optical disks.

(3) Pick Up of Optical Disc (Step S13)

Subsequently, as shown in FIG. 6, the cam 63b of the disc-holding mechanism 60 is rotated to open the open/close arms 61 by the force of the spring 62. As already explained, at this moment, the lower ends of the disc-holding pins 64 are located slightly below the lower surface of the topmost optical disc 100. Therefore, when the open/close arms 61 are opened, the inclined surfaces of the tapered portions of the disc-holding pins 64 produce a force for lifting the topmost disc 100. After that, as shown in FIG. 7B, the transfer mechanism 50 is moved upward, whereby only the topmost optical disc 100 is picked up from the supply unit 10.

At the moment when the open/close arms 61 are opened, the lower ends of the disc-holding pins 64 may possibly be at the level of the second optical disc 100 located immediately below the topmost one. In this case, the disc-holding pins 64 will initially come in contact with the inner wall of the central hole 110 of the second optical disc 100 at the lower edges of the tapered portions 64a, rather than at the circumferential surfaces of the tapered portions 64a. However, since the inner wall of the central hole 110 is vertical and smooth, the second optical disc 100 cannot be securely held by the disc-holding pins 64. Accordingly, when the disc-holding mechanism 60 is moved upward, the disc-holding pins 64 cannot bear the weight of the second optical disc 100, so that the second optical disc 100 will eventually come off the pins 64. Thus, the present system can separate the second optical disc 100 from the topmost optical disc 100 and pick up only this topmost disc 100 from the supply unit 10. For a more assured separation of the optical disks 100, after the open/close arms 61 are opened to hold the optical disc 100, the open/close arms 61 may be shaken and/or vertically moved so as to make the second optical disc 100 fall down. An even more assured separation of the second optical disc 100 can be achieved by moving the open/close arms 61 in the horizontal direction, rather than the vertical direction, to make the central hole 110 of the second optical disc 100 interfere with the center pole 12.

(4) Transfer of Optical Disc to Restoration Unit (Step S14)

Subsequently, the rotary arm 51 of the transfer mechanism 50 is rotated to transfer the optical disc 100 to the restoration unit 20. Then, the rotary arm 51 is lowered to an appropriate height directly above the restoration table 21, after which the open/close arms 61 are closed by the arm-closing mechanism 63. As a result, the optical disc 100 is released from the open/close arms 61 and the released disc 100 is set on the restoration table 21.

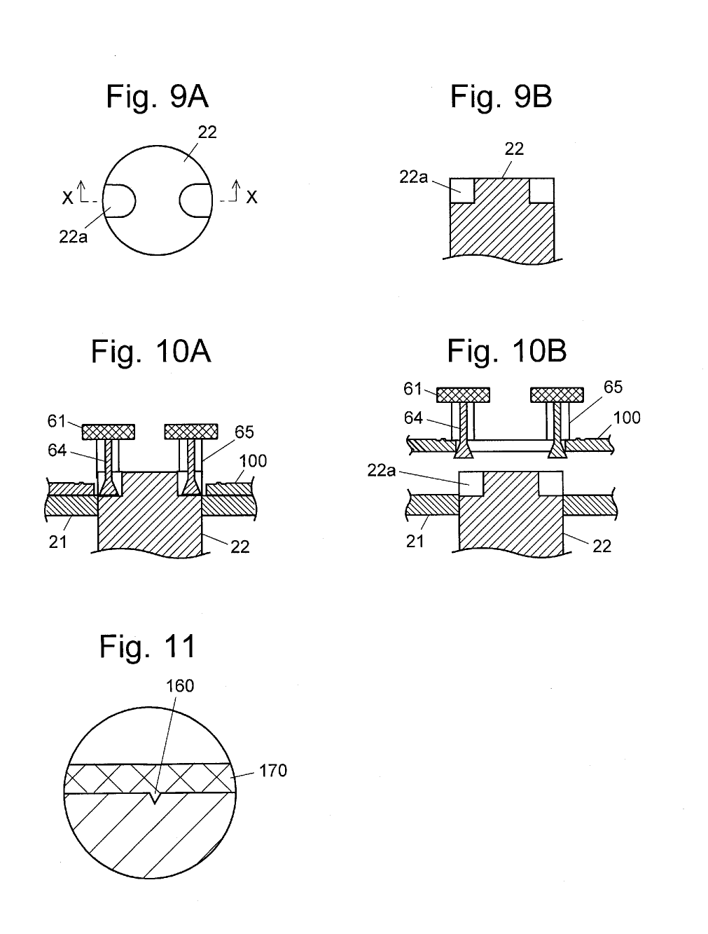

As illustrated in FIGS. 9A and 9B, the central shaft 22 of the restoration table 21 has a pair of recesses 22a for avoiding interference with the disc-holding pins 64 of the disc-holding mechanism 60. By an appropriate control of the restoration table drive motor 23, the restoration table 21 is halted at a position where the recesses 22a directly face the disc-holding pins 64. Each of the recesses 22a is open on the top side and on the lateral side of the central shaft 22 so that the disc-holding pin 64 can be inserted into or removed from the recess 22a.

In place of the recesses 22a, a mechanism for vertically moving the central shaft 22 may be provided so that the central shaft 22 can be actively refracted when the disc-holding pins 64 are moved closer to the restoration table 21. Another possible choice is to elastically support the central shaft 22 upward by a spring or the like so that the central shaft 22 can passively move downward when the disc-holding pins 64 come in contact with the central shaft 22 and press it from above.

(5) Grind/polishing and Cleaning (Step S15)

Subsequently, the grind/polishing pad 24 of the restoration unit 20 is lowered until it is pressed onto the optical disc 100 on the restoration table 21 with an appropriate pressure. In this state, the pad holder 25 and the restoration table 21 are rotated, whereby the top surface (readout surface) of the optical disc 100 is ground and polished. During this grinding and polishing process, a cleaning liquid is supplied from the liquid supply nozzle 27d to the surface of the optical disc 100 so as to remove heat and shavings resulting from the process as well as to clean the surface of the optical disc 100.

In some cases, the scratches on the optical disc 100 cannot be completely removed by the grind/polishing process. However, as shown in FIG. 11, if the remaining scratch 160 is small and shallow, the scratch can be eliminated later by applying a coating agent 170 to the disc surface and filling the scratch 160 with the coating agent 170. Accordingly, it is not always necessary to continue the grind/polishing until the scratches completely disappear.

(6) Drying (Step S16)

After the grind/polishing is completed, the grind/polishing pad 24 is moved upward, the supply of the cleaning liquid is discontinued, and the restoration table 21 is rotated at high speeds. By this operation, the cleaning liquid remaining on the optical disc 100 is removed from the surface of the disc 100 by centrifugal force. A flow of air generated by the high-speed rotation further dries the optical disc 100.

(7) Application of Coating Agent (Step S17)

Subsequently, the coating agent ejection nozzle 70 provided at the tip of the rotary arm 51 is moved to an appropriate position above the optical disc 100. Then, while the restoration table 21 is rotated at a predetermined speed, the coating agent is ejected from the nozzle 70, whereby the coating agent is evenly applied to the surface of the optical disc 100. The conditions relating to this coating process, such as the amount of ejection of the coating agent, the rotating speed of the restoration table 21, the magnitude and rate of change in the rotating speed, and the period for maintaining the rotation, are appropriately determined according to the kind of coating agent, the ambient temperature, the thickness of the coating agent to be applied, and other factors.

(8) Transfer of Optical Disc to Curing Unit (Step S18)

After the application of the coating agent to the optical disc 100, the optical disc 100 is transferred to the curing unit 30 by the transfer mechanism 50 as follows: Initially, the rotary arm 51 is rotated to bring the disc-holding mechanism 60 to a position over the restoration table 21, after which the rotary arm 51 is lowered to a height where the disc-holding pins 64 are fitted into the recesses 22a of the central shaft 22 (FIG. 10A). Subsequently, the open/close arms 61 are opened to hold the optical disc 100 on the restoration table 21 by means of the disc-holding pins 64 and the upper-side stopping pins 65, and the rotary arm 51 is moved upward (FIG. 10B), after which this arm 51 is rotated to transfer the disc 100 to the curing unit 30. Then, the rotary arm 51 is lowered to a predetermined height above the curing table 31, after which the open/close arms 61 are closed to release the optical disc 100. As a result, the optical disc 100 is set on the curing table 31. Since the disc-holding mechanism 60 of the restoration system according to the present embodiment is designed to hold the optical disc 100 at its central hole 110, the optical disc 100 can be safely transferred to the curing unit 30 without causing any damage to the coating agent before curing.

(9) Curing of Coating Agent (Step S19)

After the optical disc 100 is set on the curing table 31, the light source 34 is lowered into the vicinity of the optical disc 100 and turned on. The light from the light source 34 illuminates and cures the light-curing resin applied to the optical disc 100. During this irradiating operation, the curing table 31 is rotated by the curing table drive motor 33 so that the curing of the resin will progress evenly. Concurrently with this process of curing the coating agent, the restoration unit 20 may be operated to perform the grind/polishing or coating process for the next optical disc. Such parallel operations effectively improve the processing efficiency and enable the restoration of a larger number of optical disks within a short period of time.

(10) Discharge of Restored Disc (Step S20)

After the irradiating operation has been performed for a predetermined period of time in the curing unit 30, the optical disc 100 that has undergone the curing process is transferred from the curing table 31 to the collecting stage 41 of the discharging unit 40 by the transfer mechanism 50. Similar to the central shaft 22 of the restoration table 21, the central shaft 32 of the collecting stage 41 is also provided with recesses so that the open/close arms 61 can operate without causing interference between the disc-holding pins 64 and the central shaft 32.

The collecting stage 41 of the discharging unit 40 can hold a plurality of optical disks 100 in a stacked form. The disks that have undergone a series of processes are sequentially stacked on the collecting stage 41. After the series of processes have been completed for all the disks 100 stacked on the supply unit 10, the housing 90 of the restoration system is partially or entirely opened, and the restored disks 100 collected in the discharging unit 40 are removed from the restoration system.

As described to this point, with the optical disc restoration system according to the present embodiment and the restoration method using the same system, the readout surface of an optical disc is ground away until the scratches on that surface almost completely disappear, after which a transparent resin is applied to the readout surface to a thickness corresponding to the thickness that has been ground away. Thus, the optical disc can be restored with only a minor change in the thickness. Accordingly, the restoration can be semi-permanently repeated.

When a transparent resin whose hardness in the cured state satisfies the specifications for BDs is used as the aforementioned transparent resin, the surface hardness of the restored disc will satisfy the specifications for BDs. Thus, the present technique can be suitably used for the restoration of BDs, which has been conventionally difficult.

The optical disc restoration system according to the present embodiment also helps to reuse optical disks that have been previously non-reusable due to some defect resulting from repeated restoration by a conventional method, such as a significant warping of the surface or an excessive decrease in the thickness from the specified value. Even such a disc can be restored by grinding its surface until the warping disappears (if there is any warping) and subsequently forming a coating layer by a thickness corresponding to the decrease from the specified value. Thus, an effective use of the resources is realized.

In the restoration system according to the present embodiment, the entire process of grind/polishing, cleaning, applying a coating agent, and curing is performed within a single system. After dust or stain, which causes problems in the coating process, is removed from the surface of the optical disc in the cleaning process, a clean optical disc is directly sent to the subsequent coating process. Therefore, the restoration system according to the present embodiment requires no clean room or the like; it can be used in common environments, such as office rooms or industrial plants.

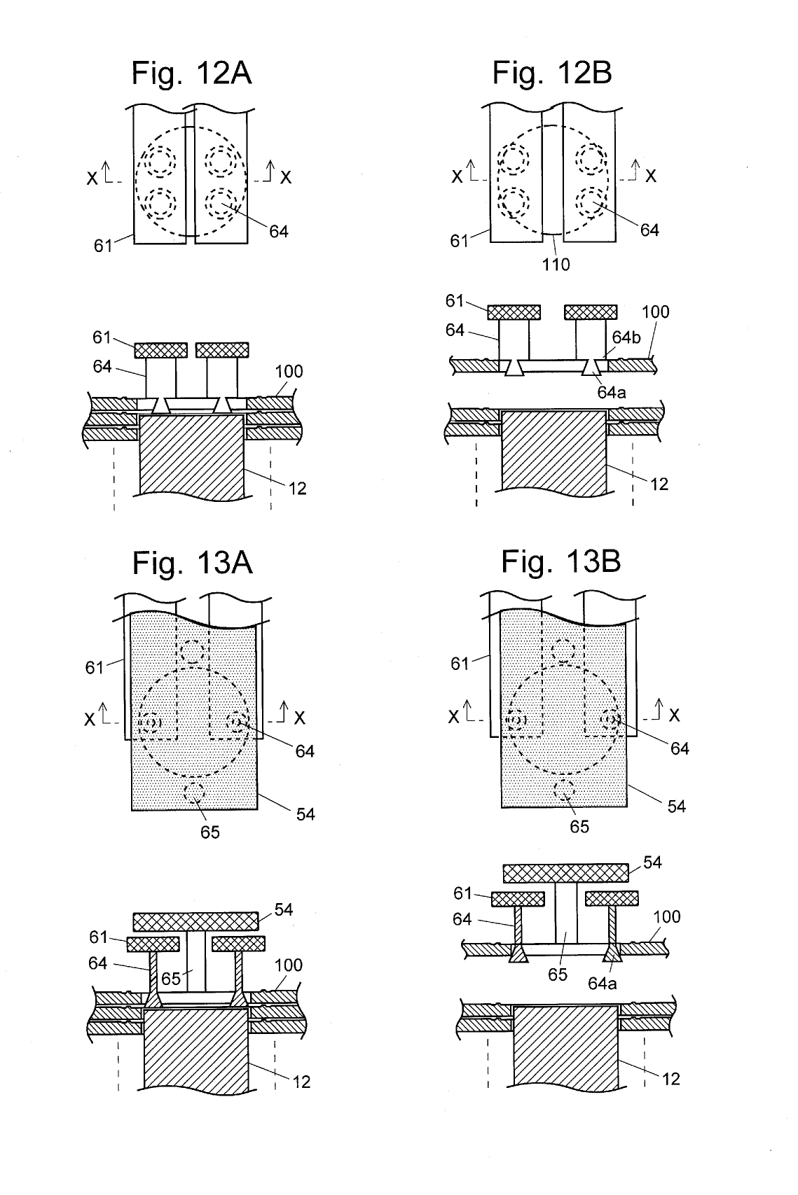

The configuration of the disc-holding mechanism 60 is not limited to the one shown in FIGS. 4-7B. FIGS. 12A-13B show two other possible examples, where each of the FIGS. 12A and 13A shows the released state, and each of the FIGS. 12B and 13B shows the holding state.

In the example shown in FIGS. 12A and 12B, each of the open/close arms 61 has two disc-holding pins 64 at its tip, and a projection 64b for holding the optical disc 100 on the upper side is provided above the tapered portion 64a of each disc-holding pin 64. According to this design, the tapered portion 64a supports the lower end of the inner wall of the central hole 110 of the optical disc 100, while the lower end of the projection 64b comes in contact with a portion around the central hole 110 on the upper surface of the disc 100. Accordingly, the optical disc 100 can be held from both the upper and lower sides even though no upper-side stopping pin 65 is provided.

In the example shown in FIGS. 13A and 13B, the upper-side stopping pins 65 do not extend from the open/close arms 61 but are attached to a plate member 54 separately provided over the rotary arm 51.

The number of disc-holding pins 64 is not limited to the previously mentioned values. For example, it is possible to provide three pins, with one pin on one of the open/close arms 61 and two pins on the other arm. Providing five or more disc-holding pins is also possible.

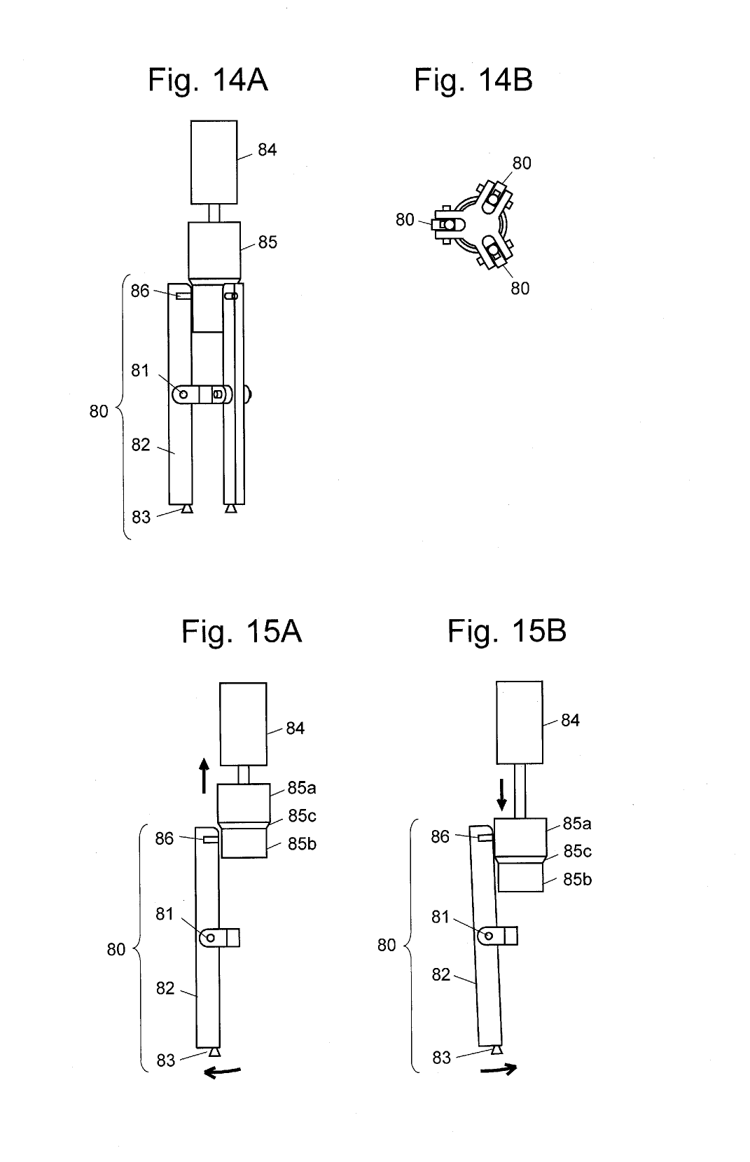

In place of the horizontally extending open/close arms 61 used in the disc-holding mechanism 60 shown in FIGS. 4-7B, vertical open/close arms may be used, as shown in FIGS. 14A-16B.

The disc-holding mechanism shown in FIGS. 14A-15B includes three open/close arms 80, a solenoid (or air cylinder) 84 located above the open/close arms 80, and a cylindrical cam 85 that can be vertically driven by the solenoid 84. It should be noted that FIGS. 15A and 15B show only one of the three open/close arms 80 for the sake of simplicity. The cylindrical cam 85, which is made of a magnetic material, is divided into the upper section 85a, the lower section 85b and the middle section 85c. The diameter of the upper section 85a is larger than that of the lower section 85b, while the diameter of the middle section 85c continuously changes between the upper and lower sections 85a and 85b. In the present example, the open/close arms 80 are designed to serve as the disc-holding pins 64 of the previous embodiment. For this purpose, a tapered portion 83 having a downward-spread conical shape is provided at the lower end of each open/close arm 80 so as to hold an optical disc from both sides by the tapered portion 83 and the step-like portion between the tapered portion 83 and the arm body 82. Each open/close arm 80 is rotatable about a rotation shaft 81 provided in the middle of the arm 80. A permanent magnet 86 is embedded in the upper portion of each arm 80 on the side facing the cylindrical cam 85. When the cylindrical cam 85 is moved upward by the action of the solenoid 84, the permanent magnets 86 of the open/close arms 80 are attracted to the lower section 85b having the smaller diameter, causing the arms 80 to rotate so that their lower ends move away from each other. Thus, the open/close arms 80 are opened (FIG. 15A). On the other hand, when the cylindrical cam 85 is moved downward, the permanent magnets 86 of the open/close arms 80 are attracted to the upper section 85a having the larger diameter, causing the arms 80 to rotate so that their lower ends move closer to each other. Thus, the open/close arms 80 are closed (FIG. 15B).

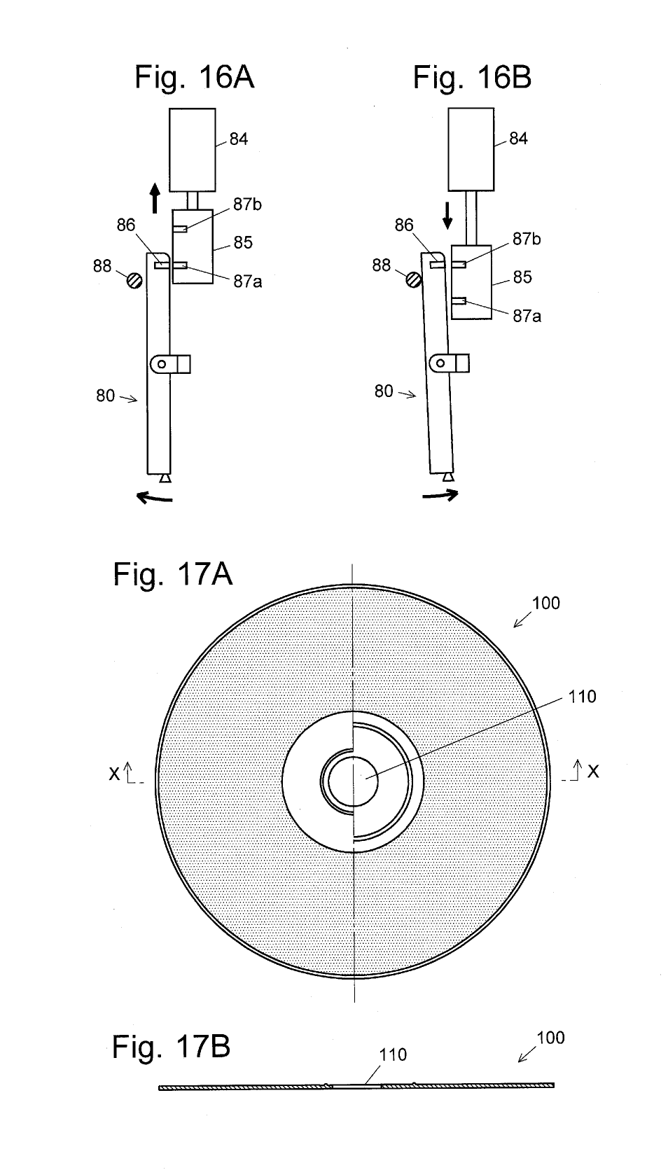

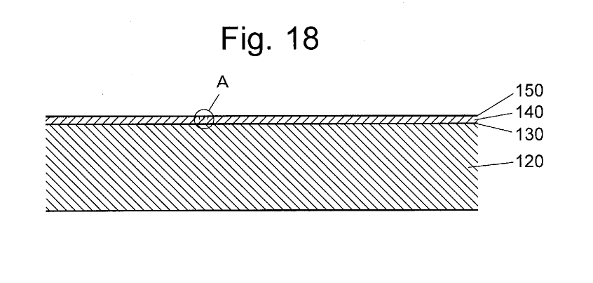

Similar to the mechanism shown in FIGS. 14A-15B, the disc-holding mechanism shown in FIGS. 16A and 16B includes three vertically extending open/close arms 80, a solenoid 84 and a cylindrical cam 85. However, the cylindrical cam 85 in the present example is made of a non-magnetic material and has the same diameter from the upper end through to the lower end. It should be noted that FIGS. 16A and 16B show only one of the three open/close arms 80 for the sake of simplicity. In the upper portion of each arm 80, a permanent magnet 86 is embedded, with a predetermined pole facing toward the cam 85. In the lower portion of the cam 85, a permanent magnet 87a is embedded in such a manner that a pole different from the aforementioned predetermined pole is directed toward the arm 80. Furthermore, another permanent magnet 87b is embedded in the upper portion of the cam 85 in such a manner that the same pole as the aforementioned predetermined pole is directed toward the arm 80. When the cylindrical cam 85 is moved upward by the action of the solenoid 84, an attracting force acts between the permanent magnets 86 of the arms 80 and the permanent magnets 87a in the lower portion of the cam 85, causing the arms 80 to rotate so that their lower ends move away from each other. Thus, the open/close arms 80 are opened (FIG. 16A). On the other hand, when the cylindrical cam 85 is moved downward, a repelling force acts between the permanent magnets 86 of the arms 80 and the permanent magnets 87b in the upper portion of the cam 85, causing the arms 80 to rotate so that their lower ends move closer to each other. Thus, the open/close arms 80 are closed (FIG. 16B). The rotation of the arm 80 caused by the repelling force of the magnets is stopped at the position where the arm 80 comes in contact with a stopper 88, which is provided near the upper end of each arm 80 to restrict the rotation of the arm 80.

Thus far, various modes for carrying out the present invention have been described by means of the embodiment. It should be noted that the present invention is not limited to the previous embodiment. It is allowed to make appropriate changes within the spirit of the present invention.

For example, although the restoration system of the previous embodiment is provided with the transfer mechanism 50 for conveying an optical disc 100 among two rotary tables (the restoration table 21 and the curing table 31) and two fixed stages (the supply stage 11 and the collecting stage 41) so as to automatically and continuously process a plurality of optical disks, such a transfer mechanism can be omitted and the system may be configured to sequentially perform the grind/polishing, cleaning, coating and curing processes on the same rotary table. In this case, for example, every time the processing of one disc is completed, a user manually removes the processed disc from the rotary table and sets the next disc on the same table.

It is also possible to provide three or more rotary tables to further improve the processing efficiency. For example, the two processes of grind/polishing the optical disc and applying the coating agent, which are performed on the same rotary table in the previous embodiment, may be individually performed on separate rotary tables. In this case, while the coating agent is being applied to one optical disc on one table, another optical disc can be grind/polished on the other table.

In the previous embodiment, both the restoration table 21 with an optical disc placed thereon and the grind/polishing pad 24 were actively rotated by the motors 23 and 26, respectively. Alternatively, it is possible to actively rotate only the grind/polishing pad 24 by a motor or the like while maintaining the grind/polishing pad 24 in contact with the optical disc 100 so that the rotation table 21 will passively rotate. Conversely, only the restoration table 21 may be actively rotated, in which case the grind/polishing pad 24 will passively rotate due to the stress.

### EXPLANATION OF NUMERALS

10 . . . Supply Unit
11 . . . Supply Stage
13 . . . Lifting Plate
20 . . . Restoration Unit
21 . . . Restoration Table
23 . . . Restoration Table Drive Motor
24 . . . Grind/polishing Pad
26 . . . Pad Drive Motor
27d . . . Supply Nozzle
30 . . . Curing Unit
31 . . . Curing Table
33 . . . Curing Table Drive Motor
34 . . . Light Source
40 . . . Discharging Unit
41 . . . Collecting Stage
50 . . . Transfer Mechanism
51 . . . Rotary Arm
52 . . . Arm-Rotating Mechanism
53a . . . Motor
53b . . . Rotation-to-Translation Conversion Mechanism
61 . . . Open/Close Arm
62 . . . Spring
63 . . . Arm-Closing Mechanism
64 . . . Disc-Holding Pin
64a . . . Tapered Portion
64b . . . Projection
65 . . . Upper-Side Stopping Pin
70 . . . Coating Agent Ejection Nozzle
100 . . . Optical Disc
110 . . . Central Hole
160 . . . Scratch
170 . . . Coating Agent

1. An optical disc restoration method, comprising steps of:
a) grinding and polishing a readout surface of an optical disc;
b) cleaning the optical disc while the optical disc is being ground and polished and/or after the optical disc is polished; and
c) coating the readout surface of the cleaned optical disc with a coating agent.

2. The optical disc restoration method according to claim 1, wherein the coating agent is colored.

3. A method for producing a restored disc, comprising a step of restoring an optical disc having a scratch on a readout surface by using the method according to claim 1.

4. A method for producing a restored disc, comprising a step of restoring an optical disc having a scratch on a readout surface by using the method according to claim 2.

5. An optical disc restoration system, comprising:
a) a grind/polisher for grinding and polishing a readout surface of an optical disc;
b) a cleaner for supplying a cleaning liquid to the readout surface of the optical disc while the optical disc is being ground or polished and/or after the optical disc is polished; and
c) a coating-agent supplier for applying a coating agent to the readout surface of the cleaned optical disc.

6. The optical disc restoration system according to claim 5, wherein the coating agent is colored.

7. A disc pick-up mechanism, comprising:
a) a plurality of disc-holding rods extending in a vertical direction;
b) a first driver for vertically moving the disc-holding rods; and
c) a second driver for horizontally moving each of the disc-holding rods so that the disc-holding rods move closer to or away from each other,
whereby a horizontally placed optical disc can be held in such a manner that the disc-holding rods being held closer to each other by the second driver are inserted from above into a central hole of the optical disc by the first driver, and then the disc-holding rods are moved away from each other by the second driver so that a circumferential surface of each of the disc-holding rods comes in contact with an inner wall of the central hole.

8. The disc pick-up mechanism according to claim 7, wherein each of the disc-holding rods has an inclined portion on a side that faces the inner wall of the central hole of the optical disc when the optical disc is held by the disc-holding rods, the inclined portion being inclined downwards toward a circumference of the optical disc and designed to support the optical disc from below by coming in contact with a lower end of the inner wall of the central hole of the optical disc.

9. The disc pick-up mechanism according to claim 8, further comprising a plurality of upper-side stopping members which come in contact with an upper side of the optical disc at a portion around the central hole thereof when the optical disc is held by the disc-holding rods.

10. The disc pick-up mechanism according to claim 8, wherein a projection protruding toward a circumference of the optical disc is provided above the inclined portion on at least a portion of the disc-holding rods so that a lower surface of the projection will come in contact with an upper side of the optical disc at a portion around the central hole thereof when the optical disc is held by the disc-holding rods.
